(19) United States
(12) Patent Application Publication
(10) Pub. No.: US 2003/0033243 A1
(43) Pub. Date: Feb. 13, 2003

(54) System and method for wireless delivery of content over a communications network

(76) Inventors: Thomas W. Baker, Orefield, PA (US); David M. Cooley, Slatington, PA (US)

Correspondence Address: HITT GAINES & BOISBRUN P.C., P.O. BOX 832570, RICHARDSON, TX, 75083, US

(21) Appl. No.: 09/924,100

(22) Filed: Aug. 7, 2001

(51) Int. Cl. G06F 17/60

(52) U.S. Cl. 705/39

(57) ABSTRACT

A content vending machine, a method for wireless delivery of content and an information delivery system incorporating the machine or the method. In one embodiment, the content vending machine includes a request receiver associated with a request fulfiller. The request receiver receives payment information and a content request from a requestor. The request fulfiller verifies the payment information, retrieves content responsive to the content request and then wirelessly transmits the content to the requester.

### TECHNICAL FIELD OF THE INVENTION

The present invention is directed, in general, to network infrastructure and, more specifically, to a system and method for wireless delivery of content and a information delivery system employing the same.

### BACKGROUND OF THE INVENTION

The Internet provides an accessible medium for communication and the exchange of information and merchandise. In fact, consumers are now spending over three billion dollars a month for online purchases. Along with the purchasing of merchandise, other information based products are also being sought on the Internet.

One variety of products being obtained through the Internet includes digital data products that are easily distributed. For instance, digital data products including computer programs, videos and music are stored on computers and then e-mailed to Internet users. In addition, web sites are available to further distribute the digital information.

Besides being easily distributed, the copies are also of high quality. Thus, an owner of a digital data product can distribute high quality copies to many end users at minimal cost to the recipients. Though this allows more users the benefit of the products, this free distribution may also prevent copyright holders from positively receiving payment for their work. Copyright holders, therefore, are often reluctant to use the current distribution channels of digital data products, especially on the Internet.

To alleviate this problem, payment for some digital data products are requested on a voluntarily basis. Also, digital data can be distributed from a web site after a pre-determined amount of funds are received for the digital data product. This allows the distribution of digital data products over the Internet while also allowing copyright holders the opportunity to receive the benefit of royalties.

These distribution and payment systems, however, still do not typically afford a copyright holder a royalty for every copy that is distributed. Whether intentionally or not, all recipients of a freely distributed digital data product may not voluntarily pay. Also, further copying and distribution after receiving a preset amount of funds still may not allow a copyright holder a royalty for every copy generated.

Additionally, these distribution and payment systems often do not easily allow an end user the benefit of a digital data product even when payment is made. For example, the product must typically first be received through an Internet connected computer. The digital data product is then often loaded onto another device before a user can enjoy it. This usually requires a hardwired connection between the computer and other devices which limits the possible locations of receiving Internet digital data products.

Accordingly, what is needed in the art is a device that wirelessly delivers digital data that allows users access to and the use of the data while, at the same time, allowing the owners of such data to be compensated, if so desired.

### SUMMARY OF THE INVENTION

To address the above-discussed deficiencies of the prior art, the present invention provides a content vending machine for wireless delivery of content. In one embodiment, the content vending machine includes a request receiver that receives payment information and a content request from a requester. The content vending machine also includes a request fulfiller, associated with the request receiver, that verifies the payment information, retrieves content responsive to the content request and then wirelessly transmits the content to the requester.

In another aspect, the present invention provides a method for wirelessly delivering content. In one embodiment, the method includes receiving payment information and a content request by a request receiver of a content vending machine from a requester and then verifying the payment information by a request fulfiller of the content vending machine that is associated with the request receiver. After verifying the payment information, the method further includes retrieving content responsive to the content request and then wirelessly transmitting the content to the requester.

In another aspect, the present invention provides an information delivery system for wireless delivery of content over a communications network that includes a content reservoir coupled to the communications network that stores content and a content vending machine, coupled to the content reservoir. The content vending machine includes a request receiver that receives payment information and a content request from a requester. The content vending machine also includes a request fulfiller, associated with the request receiver, that verifies the payment information, retrieves content responsive to the content request from the content reservoir and then wirelessly transmits the content to the requestor.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a network diagram of an embodiment of an information delivery system constructed in accordance with the principles of the present invention;

FIG. 2 illustrates a block diagram of an embodiment of a content vending machine constructed in accordance with the principles of the present invention; and

FIG. 3 illustrates a flow diagram of an embodiment of a method of wirelessly delivering content constructed in accordance with the principles of the present invention.

### DETAILED DESCRIPTION

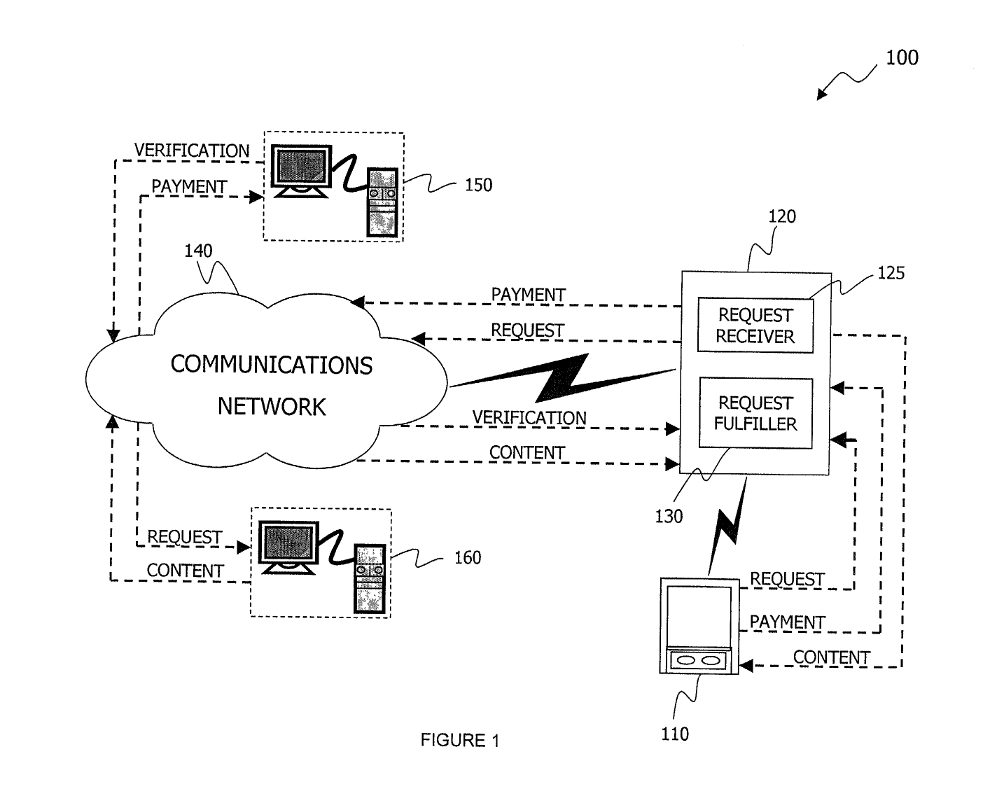

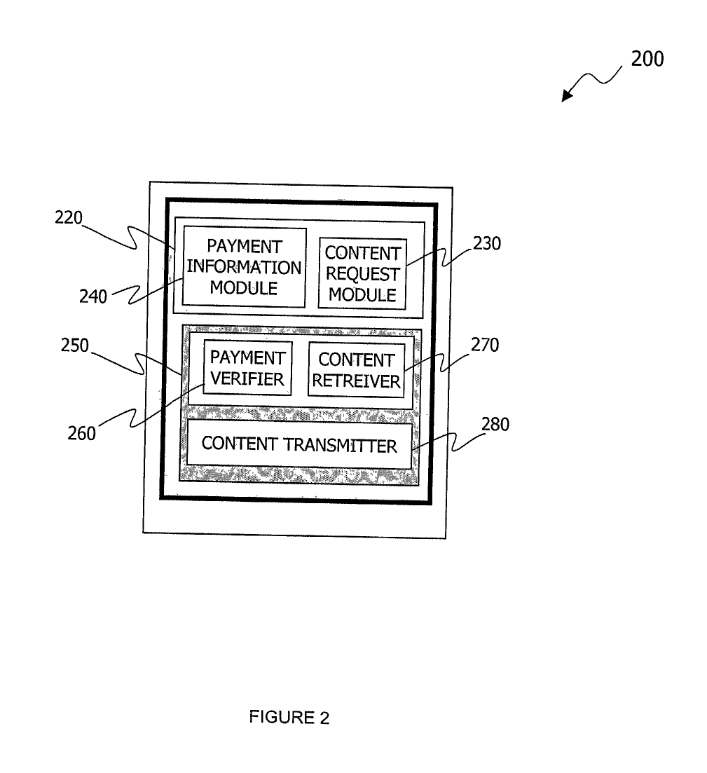

Referring initially to FIG. 1, illustrated is a network diagram of an embodiment of an information delivery system, generally designated 100, constructed in accordance with the principles of the present invention. The information delivery system 100 is coupled to a communications network 140 and includes a requester 110, a content vending machine 120, a remote payment verifier 150 and a content reservoir 160. The content vending machine 120 includes a request receiver 125 and a request fulfiller 130. In addition to the following discussion with respect to FIG. 1, both the request receiver 125 and the request fulfiller 130 are more fully discussed with respect to FIG. 2.

The requester 110 requests content from the request receiver 125 of the content vending machine 120. As shown in FIG. 1, the requester 110, may be wirelessly coupled to the content vending machine 120 wherein Bluetooth-compliant transceivers may be employed. In the illustrated embodiment, the Bluetooth-compliant transceivers are wirelessly coupled via a Bluetooth communications environment as defined in the Bluetooth Specification, Version 1.1 and incorporated herein by reference. A copy of the Bluetooth Specification, Version 1.1 can be obtained at http://www.bluetooth.com/. Alternative embodiments may wirelessly couple the requester 110 through conventional infra-red, radio frequency and other current or future wireless technologies.

After making a request, the requestor 110 also delivers payment information based on the request to the request receiver 125 of the content vending machine 120. As illustrated, the requester 110 may be a personal digital assistant (PDA). Those skilled in the pertinent art are familiar with PDAs, such as those commercially available from Palm™ by Palm Inc. of Santa Clara, Calif., Handspring™ by Handspring, Inc. of Mountain View, Calif. or other suppliers. Any PDA employed in the illustrated embodiment, however, should be equipped to operate in the Bluetooth environment as defined above or other wireless communications environment. Of course, other wireless or wireline devices fall within the broad scope of the present invention.

After receiving the payment information and content request from the requester 110, the request fulfiller 130 of the content vending machine 120 verifies that valid and correct payment information has been received. As illustrated, the content vending machine 120 may wirelessly transmit the payment information to the communications network 140. Alternatively, the content vending machine 120 may be wireline-coupled to the communications network 140. The present invention is not limited to a particular manner in which the content vending machine 120 may interact or communicate with the communications network 140 from which it derives the content.

The communications network 140, in the illustrated embodiment, may be any conventional network that supports respective communication between computers, telephony devices or other communications devices. The communications network 140 may be either wireless, hardwired or a combination of the two. In an exemplary embodiment, the communications network 140 may be the Internet. In an alternative embodiment, the communications network 140 may be an Intranet of a business. One skilled in the pertinent art also understands that the communications network 140 may employ communications between any number of content vending machines 120, remote payment verifiers 150 or content reservoirs 160.

In the illustrated embodiment, payment information is verified by the remote payment verifier 150 once it is received through the communications network 140. In alternative embodiments, payment information verification may be performed locally at the content vending machine 120. Remote payment information verification is well known in the art and may include any one of a number of conventional electronic payment systems. For a survey of currently available electronic payment systems, see “Electronic Payment Systems” by Donal O'Mahony, Michael Peirce, and Hitesh Tewart, Artech House (1997), which is incorporated herein by reference.

As shown in FIG. 1, once the payment information is verified, verification is sent via the communications network 140 to the request fulfiller 130 of the content vending machine 120. After receiving the payment information verification, the request fulfiller 130 of the content vending machine 120 then retrieves the requested content by sending a request for the requested content via the communications network 140 to the content reservoir 160. Upon receipt of the request, the content reservoir 160, sends the requested content over the communications network 140 to the request fulfiller 130 of the content vending machine 120 which subsequently transmits the content to the requester 110 through a wireless connection. In an exemplary embodiment, the content may be wirelessly transmitted via a Bluetooth-compliant transmitter.

In FIG. 1, the content reservoir 160 is a conventional computer capable of receiving, storing and delivering content through a connection to the communications network 140. In alternative embodiments, the content reservoir 160 may be a dedicated device that is constructed of special-purpose hardware employing a software program, which directs its operation.

Turning now to FIG. 2, illustrated is a block diagram of an embodiment of a content vending machine, generally designated 200, constructed in accordance with the principles of the present invention. The content vending machine 200 includes a request receiver 220 and a request fulfiller 250. It should be noted that other components not shown may be included within the content vending machine 200 without departing from the scope of the present invention. The content vending machine 200, in the illustrated embodiment, is a dedicated device that is constructed of special-purpose hardware employing a software program, which directs its operation. Other embodiments, of course, may employ a device that is solely hardwired or that is solely software enabled using general purpose hardware such as a computer.

As shown in FIG. 2, the request receiver 220 includes a content request module 230 and a payment information module 240. The content request module 230 receives requests for content selected from the content vending machine 200. In an exemplary embodiment, the requests may be received from a wirelessly coupled requester similar to the requester 110 illustrated in FIG. 1. As discussed above, the requester 110 may be wirelessly coupled to the content vending machine 200 through any conventional technology including Bluetooth, infra-red and radio frequency. In other embodiments, however, the content request module 230 may receive the request through physical interaction with the content vending machine 200. For example, one may select the requested content via a touch screen, push buttons, or any other conventional means of selection.

The payment information module 240 is coupled to the content request module 230. The payment information module 240 determines payment amount and receives payment information. In one embodiment, the payment amount is determined based on the number of items requested. Alternative embodiments, however, may determine the payment amount based on the total size of the request. Anyone skilled in the art will understand that the payment criteria may be determined as desired and may be updated remotely through a connection to a communications network. In one embodiment, the connection to the communications network may be wireless. In other embodiments, the connection to the communications network may be hardwired.

The payment information module 240 may receive the payment information in a variety of ways. In one embodiment, payment information may be delivered by a customer directly depositing the correct currency into the content vending machine 200. In the illustrated embodiment, payment information verification is located internal to the content vending machine 200. Alternative embodiments may accept payment information by way of an optical or magnetic reader, such as is conventionally employed to read credit cards or debit cards. In an exemplary embodiment, payment information may be completed by any of the methods discussed above or other conventionally known or future-developed payment methods. One skilled in the pertinent art will understand the well known operation of a vending machine receiving and verifying payment information for the delivery of a tangible object.

Associated with the request receiver 220 is the request fulfiller 250. As illustrated, the request fulfiller 250 includes a payment verifier 260, a content retriever 270 and a content transmitter 280. The payment verifier 260 receives verification that a valid payment has been offered. If cash is used, then the content vending machine 200 will verify the payment information locally. In other embodiments, the payment verifier 260 may contact a remote payment verifier 150 as shown and discussed with respect to FIG. 1.

The content retriever 270 retrieves the requested content after receiving verification from the payment verifier 260. In an exemplary embodiment, the content retriever 270 may retrieve the requested content from information directly stored in the content vending machine 200. In alternative embodiments, the content retriever 270 may send a request for content to the content reservoir 160 via the communications network as previously discussed with respect to FIG. 1.

Upon receipt of the content, the content transmitter 280 wirelessly transmits the content from the content vending machine 200 to a requestor such as the requester 110 shown in FIG. 1. As discussed above, the requester may be wirelessly coupled to the content vending machine 200 through any conventional technology including Bluetooth, infra-red and radio frequency. In some embodiments, the content retriever 270 and the content transmitter 280 may be combined into one transceiver that performs both functions.

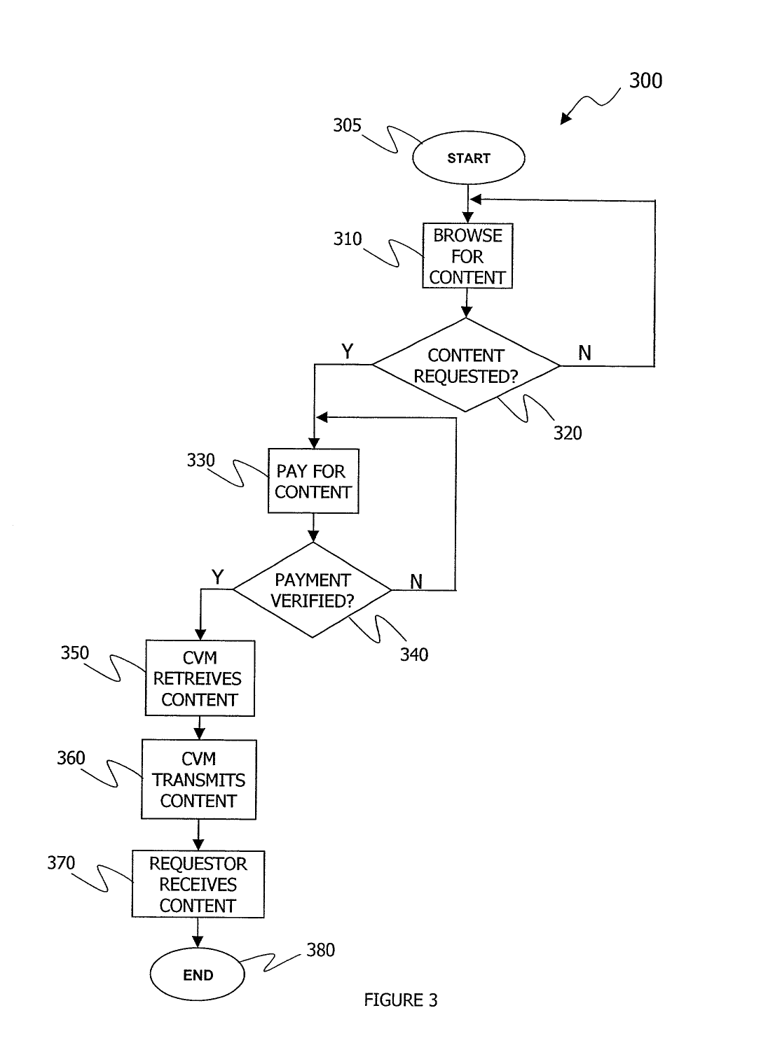

Turning now to FIG. 3, illustrated is a flow diagram of an embodiment of a method, generally designated 300, of wirelessly delivering content, constructed in accordance with the principles of the present invention. The method 300 starts in a step 305 with an intent to browse and possibly purchase content from a content vending machine (represented by CVM in FIG. 3).

After starting, a potential customer browses for content on a content vending machine in a step 310. In one embodiment, the customer may browse for content through a requestor. In alternative embodiments, the customer may browse via a touch screen or buttons located on the content vending machine.

In one embodiment of the present invention, the content is selected from a group consisting of computer data, audio data and video data. Those skilled in the pertinent art will understand that the present invention is not limited to fulfillment of any particular type of data, and is advantageously adapted to dispense copy-sensitive data, such as copyrighted music, video, or other forms of information. To address the copy-sensitivity of the data, the data may be copy-limited.

After browsing for content, a determination is made to either request content or not request content in a first decisional step 320. As previously discussed, a request for content may be performed through a requestor or by physical interaction with the content vending machine.

If it is determined that content has been requested, then payment information for the content is rendered in a step 330. In one embodiment, payment information is rendered by conventionally depositing the correct amount of cash into the content vending machine. Alternatively, if the content vending machine is connected to a communications network, then the payment information may be rendered by credit card, debit card, electronic funds transfer, or any other acceptable means of rendering payment.

A determination is then made if payment information is verified in a second decisional step 340. In an exemplary embodiment, payment information verification is completed locally at the content vending machine. In other embodiments, payment information is verified remotely from the content vending machine through a communications network.

Upon verification of the payment information, the content vending machine retrieves the requested content in a step 350. In an exemplary embodiment, the content may be stored locally and retrieved directly from the content vending machine. In an alternative embodiment, the content may be retrieved from a content reservoir via the communications network.

After receiving the content, the content vending machine transmits the content in a step 360. As discussed, the content vending machine may wirelessly transmit the content to a requester in several ways. In one embodiment, the requester may be a laptop computer. In an alternative embodiment, the requester may be a digital camera or a MP3 player. One skilled in the pertinent art will know that a requester may be any device capable of receiving electronic information.

Once the content vending machine transmits the content, a requester receives the content in a step 370. The requester may receive the content through any wireless method including those already mentioned. Finally, the wireless delivery of content ends in a step 380.

Returning now to the first decisional step 320, if content is not requested, then the method 300 returns to the step 310 wherein browsing for content continues. If payment information is not verified in the second decisional step 340, then the method 300 returns to the step 330.

Although the present invention has been described in detail, those skilled in the art should understand that they can make various changes, substitutions and alterations herein without departing from the spirit and scope of the invention in its broadest form.

What is claimed is:

1. A content vending machine for wireless delivery of content, comprising:
a request receiver configured to receive payment information and a content request from a requester; and
a request fulfiller, associated with said request receiver, configured to verify said payment information, retrieve content responsive to said content request and wirelessly transmit said content to said requester.

2. The content vending machine as recited in claim 1 wherein said payment information is configured to be wirelessly received from said requestor.

3. The content vending machine as recited in claim 1 wherein said content request is configured to be wirelessly received from said requestor.

4. The content vending machine as recited in claim 1 wherein said requestor is a personal digital assistant.

5. The content vending machine as recited in claim 1 wherein said content is selected from the group consisting of:
computer data,
audio data, and
video data.

6. The content vending machine as recited in claim 1 wherein said request fulfiller comprises a Bluetooth-compliant transmitter configured to wirelessly transmit said content to said requester.

7. The content vending machine as recited in claim 1 wherein said content vending machine is coupled to a communications network.

8. A method for wirelessly delivering content, comprising:
receiving payment information and a content request by a request receiver of a content vending machine from a requester;
verifying said payment information by a request fulfiller, associated with said request receiver, of said content vending machine;
retrieving content responsive to said content request; and
wirelessly transmitting said content to said requester.

9. The method as recited in claim 8 wherein said payment information is wirelessly received from said requester.

10. The method as recited in claim 8 wherein said content request is wirelessly received from said requester.

11. The method as recited in claim 8 wherein said requestor is a personal digital assistant.

12. The method as recited in claim 8 wherein said content is selected from the group consisting of:
computer data,
audio data, and
video data.

13. The method as recited in claim 8 wherein said wirelessly transmitting is performed by a Bluetooth-compliant transmitter.

14. The method as recited in claim 8 wherein said content vending machine is coupled to a communications network.

15. An information delivery system for wireless delivery of content over a communications network, comprising:
a content reservoir coupled to said communications network that stores content; and
a content vending machine, coupled to said content reservoir, including:
a request receiver that receives payment information and a content request from a requester; and
a request fulfiller, associated with said request receiver, that verifies said payment information, retrieves content responsive to said content request from said content reservoir and wirelessly transmits said content to said requester.

16. The information delivery system as recited in claim 15 wherein said payment information is wirelessly received from said requester.

17. The information delivery system as recited in claim 15 wherein said content request is wirelessly received from said requester.

18. The information delivery system as recited in claim 15 wherein said requester is a personal digital assistant.

19. The information delivery system as recited in claim 15 wherein said content is selected from the group consisting of:
computer data,
audio data, and
video data.

20. The information delivery system as recited in claim 15 wherein said request fulfiller comprises a Bluetooth-compliant transmitter that wirelessly transmits said content to said requestor.

21. The information delivery system as recited in claim 15 wherein said content vending machine is wirelessly coupled to said communications network.
